(19) United States
(12) Patent Application Publication
(10) Pub. No.: US 2011/0111336 A1
(43) Pub. Date: May 12, 2011

(54) Compositions and Methods for High Efficiency Absorption of Radiation, and Films Formed Thereof

(75) Inventor: Makarand P. Gore, Fort Collins, CO (US)

(73) Assignee: YewSavin, Inc., Fort Collins, CO (US)

(21) Appl. No.: 12/941,249

(22) Filed: Nov. 8, 2010

Related U.S. Application Data
(60) Provisional application No. 61/259,532, filed on Nov. 9, 2009.

(51) Int. Cl. G03G 9/00; C09D 11/00

(52) U.S. Cl. 430/105; 430/116; 430/322; 106/31.13; 427/595; 427/511

(57) ABSTRACT

An absorber with significant absorbance matching the processing radiation is included in the compositions for efficient capture of energy. Embodiments of the present disclosure can also be viewed as providing compositions that have a functional film precursor such as an ink that might include, a colorant, toner, polymer, dye, pigment, or a reactive component such as polymer precursors, and an absorber that is capable of absorbing radiation wavelength that is “matched” to the waveband of the processing radiation.

### CROSS REFERENCE

This application claims benefit to U.S. Provisional Application No. 61/259,532, entitled, Compositions and Methods for High Efficiency Absorption of Radiation, and Films Formed Thereof, filed Nov. 9, 2009, which is incorporated herein by reference in its entirety.

### TECHNICAL FIELD

The present disclosure is generally related to production of inks, toners, and films, and more particularly related to production of films by printing.

### BACKGROUND

Application of printing inks and toners, and conversion to solid films using processes such as drying by heat, or by physical transformations such as structural changes due to fusion, and chemical transformations such as polymerization or photo-thermal decomposition using radiation, are used in many coatings such as painting, electronics manufacture, printing, protective paints, and coatings. A particularly powerful and fast emerging technology is digital printing. Large-scale digital printing is done by application of fluid in precise drops using piezo, thermal inkjet devices and liquid electro photography (LEP). In conventional presses, fluids are applied using offset, gravure, screen, flexographic, and dry toner electro photography (EP). The film precursors applied in this manner are exposed to energy using conventional heating or bulk exposure to radiation lamps. This is very inefficient due to bulk heating and low capture of radiation by the films precursor mixtures. For example, a system used by FUJI/XEROX describes high power xenon lamps used in fusion of toners. The film formation is caused by energy, either by direct bulk or blackout heating of the chambers and towers, or by a complete swath of radiation across the media, heating major portions of the film and substrates. A recently filed patent application Ser. No. 12/912,116, entitled “Systems and Methods of Energy on Demand Processing of Films”, filed Oct. 26, 2010; incorporated here in its entirety; describes concept of energy delivery to films and film precursors using a light source with matching frequencies. The Energy on Demand processes offer to overcome the bulk heating and low energy capture. However, the “Energy on Demand” processes are not effective for films and precursors that have low or no intrinsic absorption in the waveband of processing radiation.

### SUMMARY

Example embodiments of the present disclosure provide compositions and methods for high efficiency absorption of radiation, and films formed thereof. Briefly described, in architecture, one example embodiment of the composition, among others, can be implemented as follows: a film precursor; and an absorber configured to absorb radiation at a wavelength of a particular radiated energy.

Embodiments of the present disclosure can also be viewed as providing methods for high efficiency absorption of radiation, and films formed thereof. In this regard, one embodiment of such a method, among others, can be broadly summarized by the following steps: depositing a composition on a substrate, the composition comprising a film precursor and an absorber; and irradiating the composition with a particular wavelength, the absorber having been selected to absorb radiation at the particular wavelength.

### BRIEF DESCRIPTION OF DRAWINGS

FIG. 1 is a schematic spectrum of an example embodiment of ink containing the matched absorber for liquid ink applied using inkjet printer.

FIG. 2 provides illustrations of example embodiments of effecting wavelength, absorber wavelength and functional color wavelength.

FIG. 3 provides example embodiments of structures of absorbers with corresponding maximum absorption wavelength band.

FIG. 4—provides example embodiments of systems of use of ink compositions containing a “matched” absorber.

### DETAILED DESCRIPTION

Embodiments of the present disclosure will be described more fully hereinafter with reference to the accompanying drawings in which like numerals represent like elements throughout the several figures, and in which example embodiments are shared. Embodiments of the claims may, however, be embodied in many different forms and should not be construed to be limited to the embodiments set forth herein. The examples set forth herein are non-limiting examples, and are merely examples among other possible examples. The term “matched band” is defined as the match between the absorption band of the precursors or films, and the emission band of the radiation source; which may have less than 100 nm difference in the wavelengths at full-width, half max band of absorption and emission spectrum.

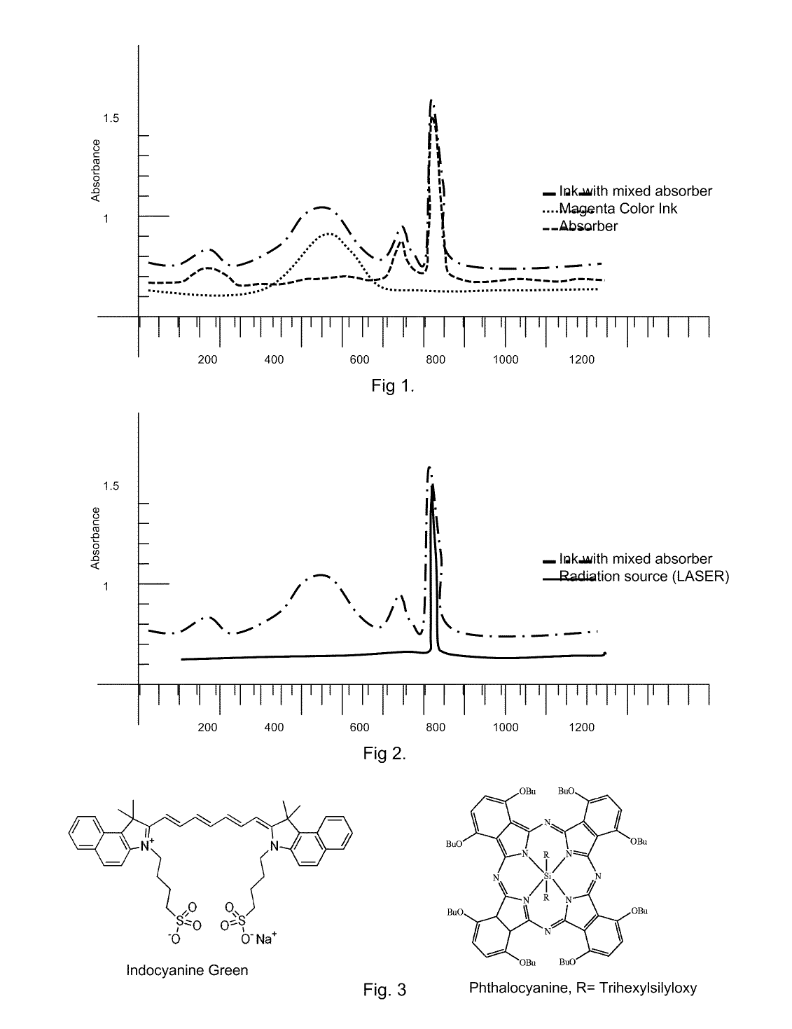

An absorber with significant absorbance matching the processing radiation is included in the compositions for efficient capture of energy. Embodiments of the present disclosure can also be viewed as providing compositions that have a functional film precursor such as an ink that might include, a colorant, toner, polymer, dye, pigment, or a reactive component such as polymer precursors, and an absorber that is capable of absorbing radiation wavelength that is “matched” to the waveband of the processing radiation. FIG. 1 illustrates this concept of modifying absorption of the film by additions of an absorber. The dotted line graph of the magenta ink shows there is no significant absorption of radiation at ˜780 nm in the original ink. The broken line graph of the absorber shows significant absorption at ˜780 nm, but no absorption in visual wavelengths. The Morse code line of the ink of this disclosure shows the absorber+ink combination with two functional wavelengths of absorption, one for the visual range and another at 780 nm for effecting radiation absorption. The “matching” of radiation may be achieved by choosing an absorber that has molar absorption coefficient “Epsilon” of at least >10,000 within approximately 100 nm of the FWHM wavelength of the effecting radiation.

In the case of films with color functions such as in printing, the relative absorbance of the absorber is preferably 10× lesser in the visual spectrum than in the effecting radiation to avoid any interference for the absorber. In the best cases, it is possible to choose an absorber having 100× to 1000× lesser absorbance in the visual region. In cases where the effecting radiation matches and is of same wavelength as the ‘functional’ absorption wavelength, this interference is not present. The graphs in FIG. 2 show the illustrations of effecting wavelength, absorber wavelength and functional color wavelength. The Morse code line of the ink of this disclosure shows the absorber+ink combination with two functional wavelengths of absorption, one for the visual range and another at 780 nm for effecting radiation absorption. The solid line graph shows the emission frequencies of the radiation source, in this case a 780 nm LED LASER. The absorption band is overlapped with the radiation band, at OD of 1.5, more than 90% radiation at 780 nm band is absorbed.

The compositions that include the absorber of the current disclosure are tailored to the particular application such as color or contrast in any part of the electromagnetic spectrum, for example, in case of non-impact printing inks such as inkjet inks. The inks contain dyes or pigments, surface modified pigments surfactants, humectants, anti-curl agents, anti-kogation agents, solvents, water, dispersants, viscosity modifiers, encapsulated colorants and the like. A non-limiting example of colorants used in inkjet inks is water-soluble black chromophore commercially available from colorant vendors such as Cabot Corp. and Orient Chemical; however, any pigment known in ink-jet printing may be useful.

In compositions where the films are printed inks, coloring function components such as dyes are pigments are used as part of film precursors.

Dyes that may be employed include both water-soluble and water-insoluble dyes. Any water-soluble or water-insoluble dye that is compatible with ink-jet printing may be suitably employed. Examples of water-soluble dyes that may suitably be employed include, but are not limited to, C. I. Acid Blue 9, C. I. Acid Red 18, C. I. Acid Red 27, C. I. Acid Red 52, C. I. Acid Yellow 23, and C. I. Direct Blue 199, and their monovalent alkali earth ions such as Na.sup.+, Li.sup.+, Cs.sup.+, NH.sub.4.sup.+, and substituted ammonium salts. Examples of water-insoluble dyes that may suitably be employed include, but are not limited to, Isol Yellow, Isol Red, Isol Orange, Isol Black, and Solvent Blue B, all of which are commercially available from Crompton & Knowles (Charlotte, N.C.); Sepisol Fast Black CN, Sepisol Fast Blue MBSN II, Sepisol Fast Red SB, and Sepisol Fast Yellow TN, all commercially available from BIMA 83 (Cemay, France), and Solvent Red 218. The dye(s) is present from about 0.1 to about 10 wt % in the ink composition.

The following pigments are useful in the practice of the systems and methods disclosed herein; however, this listing is not intended to limit the disclosure. The following pigments are available from BASF: Paliogen® Orange, Heliogen® Blue L 6901 F, Heliogen® Blue NBD 7010, Heliogen® Blue K 7090, Heliogen® Blue L 7101F, Paliogen® Blue L 6470, Heliogen® Green K 8683, and Heliogen® Green L 9140. The following pigments are available from Cabot: Monarch® 1400, Monarch® 1300, Monarch® 1100, Monarch® 1000, Monarch® 900, Monarch® 880, Monarch® 800, and Monarch® 700.

The following pigments are available from Ciba-Geigy: Chromophtal® Yellow 3G, Chromophtal® Yellow GR, Chromophtal® Yellow 8G, Igrazin® Yellow 5GT, Igralite® Rubine 4BL, Monastral® Magenta, Monastral® Scarlet, Monastral® Violet R, Monastral® Red B, and Monastral® Violet Maroon B.

The following pigments are available from Columbian: Raven 7000, Raven 5750, Raven 5250, Raven 5000, and Raven 3500. The following pigments are available from Degussa: Color Black FW 200, Color Black FW 2, Color Black FW 2V, Color Black FW 1, Color Black FW 18, Color Black S 160, Color Black S 170, Special Black 6, Special Black 5, Special Black 4A, Special Black 4, Printex U, Printex V, Printex 140U, and Printex 140V.

The following pigment is available from DuPont: Tipure® R-101. The following pigments are available from Heubach: Dalamar® Yellow YT-858-D and Heucophthal® Blue G XBT-583D. The following pigments are available from Hoechst: Permanent Yellow GR, Permanent Yellow G, Permanent Yellow DHG, Permanent Yellow NCG-71, Permanent Yellow GG, Hansa Yellow RA, Hansa Brilliant Yellow 5GX-02, Hansa Yellow-X, Novoperm Yellow HR, Novoperm® Yellow FGL, Hansa Brilliant Yellow 10GX, Permanent Yellow G3R-01, Hostaperm® Yellow H4G, Hostaperm® Yellow H3G, Hostaperm® Orange GR, Hostaperm® Scarlet GO, and Permanent Rubine F6B.

The following pigments are available from Mobay: Quindo® Magenta, Indofast® Brilliant Scarlet, Quindo® Red R6700, Quindo® Red R6713, and Indofast® Violet. The following pigments are available from Sun Chem: L74-1357 Yellow, L75-1331 Yellow, and L75-2577 Yellow.

Pigments used may be properly selected depending upon the type (color) of the ink composition to be prepared using the pigment dispersion liquid according to the present disclosure. Examples of pigments for yellow ink compositions include C.I. Pigment Yellow 1, C.I. Pigment Yellow 2, C.I. Pigment Yellow 3, C.I. Pigment Yellow 12, C.I. Pigment Yellow 14, C.I. Pigment Yellow 16, C.I. Pigment Yellow 17, C.I. Pigment Yellow 73, C.I. Pigment Yellow 74, C.I. Pigment Yellow 75, C.I. Pigment Yellow 83, C.I. Pigment Yellow 93, C.I. Pigment Yellow 95, C.I. Pigment Yellow 97, C.I. Pigment Yellow 98, C.I. Pigment Yellow 109, C.I. Pigment Yellow 110, C.I. Pigment Yellow 114, C.I. Pigment Yellow 128, C.I. Pigment Yellow 129, C.I. Pigment Yellow 138, C.I. Pigment Yellow 139, C.I. Pigment Yellow 147, C.I. Pigment Yellow 150, C.I. Pigment Yellow 151, C.I. Pigment Yellow 154, C.I. Pigment Yellow 155, C.I. Pigment Yellow 180, and C.I. Pigment Yellow 185. They may be used either solely or in a combination of two or more. The use of one or at least two pigments selected from the group consisting of C.I. Pigment Yellow 74, C.I. Pigment Yellow 110, C.I. Pigment Yellow 128, and C.I. Pigment Yellow 147 is particularly preferred.

Examples of pigments for magenta ink compositions include C.I. Pigment Red 5, C.I. Pigment Red 7, C.I. Pigment Red 12, C.I. Pigment Red 48 (Ca), C.I. Pigment Red 48 (Mn), C.I. Pigment Red 57 (Ca), C.I. Pigment Red 57:1, C.I. Pigment Red 112, C.I. Pigment Red 122, C.I. Pigment Red 123, C.I. Pigment Red 168, C.I. Pigment Red 184, C.I. Pigment Red 202, C.I. Pigment Red 209, and C.I. Pigment Violet 19. They may be used either solely or in a combination of two or more. The use of one or at least two pigments selected from the group consisting of C.I. Pigment Red 122, C.I. Pigment Red 202, C.I. Pigment Red 209, and C.I. Pigment Violet 19 is particularly preferred.

Examples of pigments for cyan ink compositions include C.I. Pigment Blue 1, C.I. Pigment Blue 2, C.I. Pigment Blue 3, C.I. Pigment Blue 15:2, C.I. Pigment Blue 15:3, C.I. Pigment Blue 15:4, C.I. Pigment Blue 15:34, C.I. Pigment Blue 16, C.I. Pigment Blue 22, and C.I. Pigment Blue 60; and C.I. Vat Blue 4 and C.I. Vat Blue 60. They may be used either solely or in a combination of two or more. The use of C.I. Pigment Blue 15:3 and/or C.I. Pigment Blue 15:4 is particularly preferred. C.I. Pigment Blue 15:3 is still more preferred.

Examples of pigments for black ink compositions include inorganic pigments, for example, carbon blacks (C.I. Pigment Black 7) such as furnace black, lamp black, acetylene black, and channel black and iron oxide pigments; and organic pigments, for example, aniline black (C.I. Pigment Black 1).

A variety of vehicles can be used to print the colorants. Examples of vehicle components include, but are not limited to, water, aliphatic alcohols, aromatic alcohols, diols, glycol ethers, poly(glycol) ethers, caprolactams, formamides, acetamides, and long chain alcohols. Examples of compounds employed in the practice of this disclosure include, but are not limited to, primary aliphatic alcohols of 30 carbons or less, primary aromatic alcohols of 30 carbons or less, secondary aliphatic alcohols of 30 carbons or less, secondary aromatic alcohols of 30 carbons or less, 1,2-alcohols of 30 carbons or less, 1,3-alcohols of 30 carbons or less, 1,5-alcohols of 30 carbons or less, ethylene glycol alkyl ethers, propylene glycol alkyl ethers, poly(ethylene glycol) alkyl ethers, higher homologs of poly(ethylene glycol) alkyl ethers, poly(propylene glycol) alkyl ethers, higher homologs of poly(propylene glycol) alkyl ethers, N-alkyl caprolactams, unsubstituted caprolactams, substituted formamides, un-substituted formamides, substituted acetamides, and unsubstituted acetamides. Specific examples of co-solvents that are preferably employed include, but are not limited to, 1,5-pentanediol, 2-pyrrolidone, 2-ethyl-2-hydroxymethyl-1,3-propanediol, diethylene glycol, 3-methoxybutanol, and 1,3-dimethyl-2-imidazolidinone. The cosolvent concentration may range from 0 to about 50 wt %, with about 0.1 wt % to 15 wt % being preferred.

Water-soluble surfactants may be employed in the formulation of the vehicle of the ink. For convenience, examples of surfactants are divided into two categories: (1) non-ionic and amphoteric and (2) ionic. The former class includes: TERGITOLs, which are alkyl polyethylene oxides available from Union Carbide, for example; TRITONs, which are alkyl phenyl polyethylene oxide surfactants available from Rohm & Haas Co.; BRIJs; PLURONICs (polyethylene oxide block copolymers); and SURFYNOLs (acetylenic polyethylene oxides available from Air Products); POE (polyethylene oxide) esters; POE diesters; POE amines; protonated POE amines; POE amides; and dimethicone copolyols. Ionic surfactants such as substituted amine oxides are useful in the practice of this disclosure. U.S. Pat. No. 5,106,416, Bleed Alleviation Using Zwitterionic Surfactants and Cationic Dyes discloses more fully most of the surfactants listed above.

Specific examples of amphiphiles/surfactants that are preferably employed include, but are not limited to, isohexadecyl ethylene oxide 20, SURFYNOL CT-111, TERGITOL 15-S-7, and amine oxides, such as N,N-dimethyl-N-docecyl amine oxide, N,N-dimethyl-N-tetradecyl amine oxide, N,N-dimethyl-N-hexadecyl amine oxide, N,N-dimethyl-N-octadecyl amine oxide, and N,N-dimethyl-N-(Z-9-octadecenyl)-N-amine oxide. The concentration of the amphiphiles/surfactants may range from 0 to about 40 wt %, with 2.5 wt % being preferred.

Another type of compositions of this disclosure are dry and liquid toners containing an absorber in the effecting wavelengths, such as those useful in non-impact printing methods of dry toner (EP) and liquid toner electro-photography (LEP). The EP and LEP toners are composed of colorants, polymers, and carrier liquids as in case of LEP. The toners may contain a colorant, a resin, a binder, and rheology modifying agents. Visible image forming methods associated with toners using electrophotographic systems have been extensively studied and are currently widely used. Typical examples of these techniques are dual-component developing methods, which use image-forming particles and often larger carrier particles, and mono-component developing methods, which use a toner comprising only magnetic or non-magnetic image-forming particles. Details of such developing methods are described in Kirk-Othmer, Encyclopedia of Chemical Technology, 4.sup.th ed., 9:261-275 (1994).

An example embodiment of a toner resin may include a partially cross-linked unsaturated resin such as unsaturated polyester prepared by crosslinking a linear unsaturated resin (hereinafter called base resin), such as linear unsaturated polyester resin, in embodiments, with a chemical initiator, through a reactive extrusion in a melt mixing device such as, for example, an extruder at high temperature (e.g., above the glass transition temperature of the resin, and more specifically, up to about 150.degree. C. above that glass transition temperature) and under high shear. In addition, the toner resin may possess, for example, a weight fraction of the microgel (gel content) in the resin mixture of from about 0.001 to about 50 weight percent, from about 1 to about 20 weight percent, or about 1 to about 10 weight percent, or from about 2 to about 9 weight percent. The linear portion may be comprised of base resin, more specifically unsaturated polyester, in the range of from about 50 to about 99.999 percent by weight of the toner resin, or from about 80 to about 98 percent by weight of the toner resin. More specifically, the range may be between about 81.6 and 67.1% by weight of linear portion of the resin and between about 7.5 and 18% by weight of the cross-linked resin portion. The linear portion of the resin may comprise low molecular weight reactive base resin that did not crosslink during the crosslinking reaction, more specifically unsaturated polyester resin.

The molecular weight distribution of the resin thus may be bimodal having different ranges for the linear and the cross-linked portions of the binder. The number average molecular weight (M.sub.n) of the linear portion as measured by gel permeation chromatography (GPC) is from, for example, about 1,000 to about 20,000, or from about 3,000 to about 8,000. The weight average molecular weight (M.sub.w) of the linear portion is from, for example, about 2,000 to about 40,000, or from about 5,000 to about 20,000. The weight average molecular weight of the gel portions is greater than 1,000,000. The molecular weight distribution (M.sub.w/M.sub.n) of the linear portion is from about 1.5 to about 6, or from about 1.8 to about 4. The onset glass transition temperature (Tg) of the linear portion as measured by differential scanning calorimetry (DSC) is from about 50.degree. C. to about 70.degree. C. The resin may include between about 5% and about 10% by weight of magenta pigment and between about 3% and about 7% by weight of charge control agent.

Moreover, the binder resin, especially the crosslinked polyesters, may provide a low melt toner with a minimum fix temperature of from about 100.degree. C. to about 200.degree. C., or from about 100.degree. C. to about 160.degree. C., or from about 110.degree. to about 140.degree. C.; may provide the low melt toner with a wide fusing latitude to minimize or prevent offset of the toner onto the fuser roll; and may maintain high toner pulverization efficiencies. The toner resins and thus toners, may show minimized or substantially no vinyl or document offset.

Examples of unsaturated polyester base resins are prepared from diacids and/or anhydrides such as, for example, maleic anhydride, fumaric acid, and the like, and mixtures thereof, and diols such as, for example, propoxylated bisphenol A, propylene glycol, and the like, and mixtures thereof. An example of a suitable polyester is poly(propoxylated bisphenol A fumarate).

In example embodiments, the toner binder resin may be generated by the melt extrusion of (a) linear propoxylated bisphenol A fumarate resin, and (b) crosslinked by reactive extrusion of the linear resin with the resulting extrudate comprising a resin with an overall gel content of from about 2 to about 9 weight percent. Linear propoxylated bisphenol A fumarate resin is available under the trade name SPAR II™ from Resana S/A Industrias Quimicas, Sao Paulo Brazil, or as NEOXYL P2294™ or P2297™ from DSM Polymer, Geleen, The Netherlands, for example. For suitable toner storage and prevention of vinyl and document offset, the polyester resin blend more specifically has a Tg range of from, for example, about 52.degree. C. to about 64.degree. C. Known colorants may be used. Examples of a black pigment include carbon black, such as furnace black, channel black, acetylene black and thermal black, copper oxide, manganese dioxide, titanium oxide, aniline black, activated carbon, non-magnetic ferrite and magnetite. Examples of a yellow pigment include chrome yellow, zinc yellow, yellow iron oxide, cadmium yellow, Hansa Yellow, Hansa Yellow 10G, Benzidine Yellow G, Benzidine Yellow GR, Threne Yellow, Quinoline Yellow and Permanent Yellow NCG.

Examples of an orange pigment include red chrome yellow, molybdenum orange, Permanent Orange GTR, Pyrazolone Orange, Vulkan Orange, Benzidine Orange G and Indanthrene Brilliant Orange GK.

Examples of a red pigment include red iron oxide, cadmium red, red lead, mercury sulfide, Watchyoung Red, Permanent Red 4R, Lithol Red, Brilliant Carmine 3B, Brilliant Carmine 6B, Du Pont Oil Red, Pyrazolone Red, Rhodamine B Lake, Lake Red C, Rose Bengal, Eosine Red and Alizarin Lake.

Examples of a blue pigment include ultramarine, cobalt blue, Alkali Blue Lake, Victoria Blue Lake, Fast Sky Blue, Indanthrene Blue BC, Aniline Blue, Ultramarine Blue, Calco Oil Blue, Methylene Blue Chloride, Phthalocyanine Blue, Phthalocyanine Green and Malachite Green Oxalate. Examples of a violet pigment include Manganese Violet, Fast Violet B and Methyl Violet Lake. Examples of a green pigment include chromium oxide, Chromium Green, Pigment Green, Malachite Green Lake and Final Yellow Green G. Examples of a white pigment include zinc white, titanium oxide, antimony white and zinc sulfate. Examples of a body pigment include barytes, barium carbonate, clay, silica, white carbon, talc and alumina white. Furthermore, examples of a dye include various dyes, such as basic, acidic, dispersion and direct dyes, for example, nigrosine, Methylene Blue, Rose Bengal, Quinoline Yellow and Ultramarine Blue.

There are some cases where the colorant may be used after dispersing in an aqueous system with a surfactant having polarity by a homogenizer. In the cases, polar resin fine particles having an acid value of from 10 to 50 mg KOH/g and a volume average particle diameter of 100 nm or less may be used in an amount of from 0.4 to 10% by weight, and preferably from 1.2 to 5.0% by weight, to coat the colorant. The toners may also contain charging agents. In example embodiments of liquid electrophotography, carrier liquids such as hydrocarbons (e.g. isopar) and dissolved or dispersed absorbers may be used. In addition to the above examples, The printing ink for what are known as mechanical printing processes, such as offset printing, letterpress printing, flexographic printing, intaglio printing, or screen printing may be transferred to the print feed stock via contact between the print feed stock and a printing plate or printing block provided with printing ink. Printing inks for these printing processes may comprise solvents, colorants, binders, and also various additives, such as plasticizers, antistatic agents or waxes. Printing inks for mechanical printing processes may comprise high-viscosity paste printing inks for offset printing and letterpress printing, and also liquid printing inks with comparatively low viscosity for flexographic printing and intaglio printing. Additional examples of inks are disclosed by way of example in “Printing Inks”—Ullmann's Encyclopedia of Industrial Chemistry, Sixth Edition, 1999 Electronic Release, where the inks are modified by addition of a radiation absorber ‘matched’ to the processing radiation.

Any toner or inkjet ink or component can be modified by simply adding, homogeneously dispersing, or dissolving the absorber in the ink or toner. The amount of absorber required is generally less than 20% by wt, in some cases 1% by wt. or in most preferred cases less than 1% wt. The use of high epsilon absorbers with FWHM of 200 nm allow for the lowest signature of the absorber in the function of ink such as color.

A variety of absorbers may be used in example embodiments. FIG. 3 shows compounds of two of such compounds, one an indocyanine dye, and second, a phthalocyanine dye known to be stable to light. Generally, the absorption coefficients of these dyes or pigments are in excess of 100,000. Additional examples of dyes useful in practice of this disclosure are mentioned in U.S. Pat. No. 7,083,094, Aug. 1, 2006; incorporated herein by reference. According to one example, films or film precursors with enhanced absorption include an antenna package uniformly distributed/dissolved in at least one and preferably all phase(s) of the films or precursors in order to customize the resulting coating to a radiation at a specified wavelength and (reduced) power. The antenna dyes included in the present optional antenna package may be selected from a number of radiation absorbers such as, but not limited to, aluminum quinoline complexes, porphyrins, porphins, indocyanine dyes, phenoxazine derivatives, phthalocyanine dyes, polymethyl indolium dyes, polymethine dyes, guaiazulenyl dyes, croconium dyes, polymethine indolium dyes, metal complex IR dyes, cyanine dyes, squarylium dyes, chalcogeno-pyryloarylidene dyes, indolizine dyes, pyrylium dyes, quinoid dyes, quinone dyes, azo dyes, and mixtures or derivatives thereof. Other suitable antennas may also be used in the example systems and methods and are known to those skilled in the art and can be found in such references as “Infrared Absorbing Dyes”, Matsuoka, Masaru, ed., Plenum Press, New York, 1990 (ISBN 0-306-43478-4) and “Near-Infrared Dyes for High Technology Applications”, Daehne, Resch-Genger, Wolfbeis, Kluwer Academic Publishers (ISBN 0-7923-5101-0), both incorporated herein by reference.

In another example, antenna dyes included in the present antenna package may be selected to correspond to a radiation generated by a known radiation generating device. According to one example, the media processing system may include a radiation generating device configured to produce one or more lasers with wavelength values including, but in no way limited to, approximately 300 nm to approximately 600 nm, approximately 650 nm, approximately 780 nm, approximately 808 nm, and/or approximately 1120 nm. By selectively matching the wavelength values of the radiation generating device(s), image formation may be maximized at lower power levels. According to one exemplary embodiment, the image formation using the antenna dyes may be performed at power levels as low as 5 mW/cm2 and lower.

According to an example embodiment, antenna dyes that may be used to selectively sensitize the above-mentioned coating to a wavelength of between approximately 300 nm and 600 nm include, but are in no way limited to, cyanine and porphyrin dyes such as etioporphyrin 1 (CAS 448-71-5), phthalocyanines and naphthalocyanines such as ethyl 7-diethylaminocoumarin-3-carboxylate (.lamda. max=418 nm). Specifically, according to one exemplary embodiment, appropriate antenna dyes include, but are in no way limited to, aluminum quinoline complexes, porphyrins, porphins, and mixtures or derivatives thereof. Non-limiting specific examples of suitable radiation antenna can include 1-(2-chloro-5-sulfophenyl)-3-methyl-4-(4-sulfophenyl)azo-2-pyrazolin-5-one disodium salt lamda.max=400 nm); ethyl 7-diethylaminocoumarin-3-carboxylate (.lamda.max=418 nm); 3,3′-diethylthiacyanine ethylsulfate (.lamda.max=424 nm); 3-allyl-5-(3-ethyl-4-methyl-2-thiazolinylidene)rhodanine (.lamda. max=430 nm) (each available from Organica Feinchemie GmbH Wolfen), and mixtures thereof.

Non-limiting specific examples of suitable aluminum quinoline complexes can include tris(8-hydroxyquinolinato)aluminum (CAS 2085-33-8), and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1-,2-d]1,3-dithiole, all available from Syntec GmbH.

Non-limiting examples of specific porphyrin and porphyrin derivatives may include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange (CAS 2243-76-7), Methyl Yellow (CAS 60-11-7), 4-phenylazoaniline (CAS 60-09-3), Alcian Yellow (CAS 61968-76-1), available from Aldrich chemical company, and mixtures thereof.

Further, in order to sensitize the above-mentioned coating to a radiation wavelength of approximately 650 nm, many indolium of phenoxazine dyes and cyanine dyes such as cyanine dye CS172491-724 may be selectively incorporated into one or more phases of the above-mentioned coating. Additionally, dyes having absorbance maximums at approximately 650 nm may be used including, but in no way limited to many commercially available phthalocyanine dyes such as pigment blue 15.

Further, radiation absorbing antenna dyes having absorbance maximums at approximately 650 nm according to their extinction coefficient that may be selectively incorporated into the present antenna dye package to reduce the power level initiating a color change in the coating include, but are in no way limited to, dye 724 (3H-Indolium, 2-[5-(1,3-dihydro-3,3-dimethyl-1-propyl-2H-indol-2-ylidene)-1,3-pentadien-yl]-3,3-dimethyl-1-propyl-, iodide) (.lamda. max=642 nm), dye 683 (3H-Indolium, 1-butyl-2-[5-(1-butyl-1,3-dihydro-3,3-dimethyl-2H-indol-2-ylidene)-1,3-pentadienyl]-3,3-dimethyl-, perchlorate (.lamda. max=642 nm), dyes derived from phenoxazine such as Oxazine 1 (Phenoxazin-5-ium, 3,7-bis(diethylamino)-, perchlorate) (.lamda. max=645 nm), available from “Organica Feinchemie GmbH Wollen.” Appropriate antenna dyes applicable to example embodiments of the disclosed systems and methods may also include but are not limited to phthalocyanine dyes with light absorption maximum at/or in the vicinity of 650 nm.

Radiation absorbing antenna dyes having absorbance maximums at approximately 780 nm that may be incorporated into the present antenna dye package include, but are in no way limited to, many indocyanine IR-dyes such as IR780 iodide (Aldrich 42, 531-1) (1) (3H-Indolium, 2-[2-[2-chloro-3-[(1,3-dihydro-3,3-dimethyl-1-propyl-2H-indol-2-ylidene)ethylidene]-1-cyclohexen-1-yl]ethenyl]-3,3-dimethyl-1-propyl-, iodide (9CI)), IR783 (Aldrich 54, 329-2) (2) (2-[2-[2-Chloro-3-[2-[1,3-dihydro-3,3-dimethyl-1-(4-sulfobutyl)-2Hindol-2-ylidene]-ethylidene]-1-cyclohexen-1-yl]ethenyl]-3,3-dimethyl-1-(4-sulfobutyl)-3H-indolium hydroxide, inner salt sodium salt). Additionally, low sensitivity/higher stability dyes having absorbance maximums at approximately 780 nm may be used including, but in no way limited to NIR phthalocyanine or substituted phthalocyanine dyes such as Cirrus 715 dye from Avecia, YKR186, and YKR3020 from Yamamoto chemicals. Other examples of absorbers include Lumogen IR765, Lumogen IR 788 and Lumogen IR 1050 available from BASF Chemicals, Ludwigshafen, Germany.

Similarly, high sensitivity/lower stability radiation absorbing antenna dyes having absorbance maximums at approximately 808 nm that may be incorporated into the present coating include, but are in no way limited to, Indocyanine dyes such as 3H-Indolium, 2-[2-[2-chloro-3-[(1,3-dihydro-1,3,3-trimethyl-2H-indol-2-ylidene)ethylidene]-1-cyclopenten-1-yl]ethenyl]-1,3,3-trimethyl-, salt with 4-methylbenzenesulfonic acid (1:1) (9CI), (Lambda max-797 nm), CAS No. 193687-61-5, available from “Few Chemicals GMBH”; 3H-Indolium, 2-[2-[3-[(1,3-dihydro-1,3,3-trimethyl-2H-indol-2-ylidene)ethylidene]-2-[(-1-phenyl-1H-tetrazol-5-yl)thiol]-1-cyclohexen-1-yl]ethenyl]-1,3,3-trimethyl-1-, chloride (9CI), (Lambda max-798 nm), CAS No. 440102-72-7 available from “Few Chemicals GMBH”; 1H-Benz[e]indolium, 2-[2-[2-chloro-3-[(1,3-dihydro-1,1,3-trimethyl-2H-benz[e]indol-2-ylidene)-ethylidene]-1-cyclohexen-1-yl]ethenyl]-1,1,3-trimethyl-chloride (9CI), (Lambda max-813 nm), CAS No. 297173-98-9 available from “Few Chemicals GMBH”; 1H-Benz[e]indolium, 2-[2-[2-chloro-3-[(1,3-dihydro-1,1,3-trimethyl-2H-benz[e]indol-2-ylidene)-ethylidene]-1-cyclohexen-1-yl]ethenyl]-1,1,3-trimethyl-, salt with 4-methylbenzenesulfonic acid (1:1) (9CI), (Lambda max-813 nm), CAS No. 134127-48-3, available from “Few Chemicals GMBH”, also known as Trump Dye or Trump IR; and 1H-Benz[e]indolium, 2-[2-[2-chloro-3-[(3-ethyl-1,3-dihydro-1,1-dimethyl-2Hbenz[e]indol-2-ylidene)ethylidene]-1-cyclohexen-1-yl]ethenyl]-3-ethyl-1,1-dimethyl-, salt with 4-methylbenzenesulfonic acid (1:1) (9CI) (Lambda max-816 nm), CAS No. 460337-33-1, available from “Few Chemicals GMBH”

Examples of radiation absorbers that are suitable for use in the infrared range can include, but are not limited to, polymethyl indoliums, metal complex IR dyes, indocyanine green, polymethine dyes such as pyrimidinetrione-cyclopentylidenes, guaiazulenyl dyes, croconium dyes, cyanine dyes, squarylium dyes, chalcogenopyryloarylidene dyes, metal thiolate complex dyes, bis(chalcogenopyrylo)polymethine dyes, oxyindolizine dyes, bis(aminoaryl)polymethine dyes, indolizine dyes, pyrylium dyes, quinoid dyes, quinone dyes, phthalocyanine dyes, naphthalocyanine dyes, azo dyes, hexfunctional polyester oligomers, heterocyclic compounds, and combinations thereof. Several specific polymethyl indolium compounds are available from Aldrich Chemical Company and include 2-[2-[2-chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium perchlorate; 2-[2-[2-Chloro-3-[2-(1,3-dihydro-1,3,3-trimethyl-2H-indol-2-ylidene)-ethylidene]-1-cyclopenten-1-yl-ethenyl]-1,3,3-trimethyl-3H-indolium chloride; 2-[2-[2-chloro-3-[(1,3-dihydro-3,3-dimethyl-1-propyl-2H-indol-2-ylidene)ethylidene]-1′-cyclohexen-1-yl]ethenyl]-3,3-dimethyl-1-propylindolium iodide; 2-[2-[2-chloro-3-[(1,3-dihydro-1,3,3-trimethyl-2H-indol-2-ylidene-)ethylidene]-1-cyclohexen-1-yl]ethenyl]-1,3,3-trimethylindolium iodide; 2-[2-[2-chloro-3-[(1,3-dihydro-1,3,3-trimethyl-2H-indol-2-ylidene)ethylidene]-1-cyclohexen-1-yl]ethenyl]-1,3,3-trimethylindolium perchlorate; 2-[2-[3-[(1,3-dihydro-3,3-dimethyl-1-propyl-2H-indol-2-ylidene)ethylidene-]-2-(phenylthio)-1-cyclohexen-1-yl]ethenyl]-3,3-dimethyl-1-propylindolium perchlorate; and mixtures thereof. Alternatively, the radiation absorber may be an inorganic compound, e.g., ferric oxide, carbon black, selenium, or the like. Polymethine dyes or derivatives thereof (such as a pyrimidinetrione-cyclopentylidene), squarylium dyes (such as guaiazulenyl dyes), croconium dyes, or mixtures thereof may also be used. Suitable infrared sensitive pyrimidinetrione-cyclopentylidene radiation absorbers may include, for example, 2,4,6(1H,3H,5H)-pyrimidinetrione 5-[2,5-bis[(1,3-dihydro-1,1,3-dimethyl-2H-indol-2-ylidene)ethylidene]cyclopentylidene]-1,3-dimethyl-(9CI) (S0322 available from Few Chemicals, Germany).

In other embodiments, a radiation absorber can be included that preferentially absorbs wavelengths in the range from about 600 nm to about 720 nm and more specifically at about 650 nm. Non-limiting examples of suitable radiation absorbers for use in this range of wavelengths can include indocyanine dyes such as 3H-indolium, 2-[5-(1,3-dihydro-3,3-dimethyl-1-propyl-2H-indol-2-ylidene)-1,3-pentadien-yl]-3,3-dimethyl-1-propyl-iodide), 3H-indolium, 1-butyl-2-[5-(1-butyl-1,3-dihydro-3,3-dimethyl-2H-indol-2-ylidene)-1,3-pentadienyl]-3,3-dimethyl-perchlorate, and phenoxazine derivatives such as phenoxazin-5-ium, 3,7-bis(diethylamino)perchlorate. Phthalocyanine dyes such as silicon 2,3-napthalocyanine bis(trihexylsilyloxide) and matrix soluble derivatives of 2,3-napthalocyanine (both commercially available from Aldrich Chemical), matrix soluble derivatives of silicon phthalocyanine (as described in Rodgers, A. J. et al., 107 J. Phys. Chem. A 3503-3514, May 8, 2003), matrix soluble derivatives of benzophthalocyanines (as described in Aoudia, Mohamed, 119 J. Am. Chem. Soc. 6029-6039, Jul. 2, 1997), phthalocyanine compounds such as those described in U.S. Pat. Nos. 6,015,896 and 6,025,486 (which are each incorporated herein by reference), and Projet NP800, Projet 900NP, and Project 830NP, phthalocyanine dyes and Projet 830LDI, a polymethine dye available from Fujifilm Imaging Colorants, Manchester, England, may also be used.

In still other embodiments, a radiation source, such as a laser or LED, that emits light having blue and indigo wavelengths ranging from about 380 nm to about 420 nm may be used. In particular, radiation sources such as the lasers used in certain DVD and laser disk recording equipment emit energy at a wavelength of about 405 nm. Radiation absorbers that most efficiently absorb radiation in these wavelengths may include, but are not limited to, aluminum quinoline complexes, porphyrins, porphins, and mixtures or derivatives thereof. Some specific examples of suitable radiation absorbers suitable for use with radiation sources that output radiation between 380 and 420 nm include 1-(2-chloro-5-sulfophenyl)-3-methyl-4-(4-sulfophenyl)azo-2-pyrazolin-5-one disodium salt; ethyl 7-diethylaminocoumarin-3-carboxylate; 3,3′-diethylthiacyanine ethylsulfate; 3-allyl-5-(3-ethyl-4-methyl-2-thiazolinylidene)rhodanine (each available from Organica Feinchemie GmbH Wolfen), and mixtures thereof. Other examples of suitable radiation absorbers include aluminum quinoline complexes such as tris(8-hydroxyquinolinato)aluminum (CAS 2085-33-8) and derivatives such as tris(5-cholor-8-hydroxyquinolinato)aluminum (CAS 4154-66-1), 2-(4-(1-methyl-ethyl)-phenyl)-6-phenyl-4H-thiopyran-4-ylidene)-propanedinitril-1,1-dioxide (CAS 174493-15-3), 4,4′-[1,4-phenylenebis(1,3,4-oxadiazole-5,2-diyl)]bis N,N-diphenyl benzeneamine (CAS 184101-38-0), bis-tetraethylammonium-bis(1,2-dicyano-dithiolto)-zinc(II) (CAS 21312-70-9), 2-(4,5-dihydronaphtho[1,2-d]-1,3-dithiol-2-ylidene)-4,5-dihydro-naphtho[1-,2-d]1,3-dithiole, all available from Syntec GmbH. Other examples of specific porphyrin and porphyrin derivatives can include etioporphyrin 1 (CAS 448-71-5), deuteroporphyrin IX 2,4 bis ethylene glycol (D630-9) available from Frontier Scientific, and octaethyl porphrin (CAS 2683-82-1), azo dyes such as Mordant Orange CAS 2243-76-7, Methyl Yellow (60-11-7), 4-phenylazoaniline (CAS 60-09-3), Alcian Yellow (CAS 61968-76-1), available from Aldrich chemical company, and mixtures thereof.

A variety of radiation sources as shown in Table 1. In addition to conventional IR, Xenon and UV lamps may be used in example embodiments of the systems and methods disclosed herein.

TABLE 1
Light sources:

| | Part | | Wavelengths | Source | |
|---|---|---|---|---|---|
| Company | Number | Part Name | Choice | Dimensions | Power |
| Northrop | ASM232C040 | GOLDEN | 790 to 980, with | 9.6 cm × | 40 W CW |
| Grumman | | BULLET | +/−3 nm FWHM | 0.25 cm Bar | |
| | | SUBMODULE | | | |
| Northrop | ASM232P200 | GOLDEN | 790 to 980, with | 9.6 cm × | 200 W QCW |
| Grumman | | BULLET | +/−3 nm FWHM | 0.25 cm Bar | |
| | | SUBMODULE | | | |
| Coherent | ONYX | 9010 Series HD | 808 nm, 915 nm, | 11 mm | 2000 W to |
| | MCCP | array 1.6 mm pitch | 940 nm, 975 nm | array width, | 4500 W CW |
| | 9010- | | | 1.6 mm | |
| | HDPKG | | | pitch Pump | |
| | | | | Array | |
| Coherent | 532-8V or | Prisma 532-V | 532 nm | 0.6 mm | 12 W |
| | 532 14V | | | | |
| SANYO | DL-7146- | Blue-Violet Laser | 405 nm | 0.6 mm, | 85 mw |
| | 101S | diode | | down to | |
| | | | | 300 nm | |
| | | | | collimated | |
| SANYO | DL-3147- | Red Laser diode | 650 nm | 0.6 mm, | 7 mw |
| | 060 | | | down to 1 | |
| | | | | micron | |
| | | | | collimated | |
| SHARP | GH04125A2A | Blue-Violet laser | 405 nm | 0.2 mm | 125 mw |
| | | diode | | down to | |
| | | | | 300 nm | |
| | | | | collimated | |
| SONY | SLD433S4 | 60 W array Laser | 405 nm | 7.7 mm, 24° | 60 W |
| | | diode | | Perpendicular | |
| | | | | and 8° | |
| | | | | parallel | |
| | | | | divergence | |
| Nichia | NCSU034A | Surface mount | 385 nm | 2.1 mm | 330 mw |
| | | UV LED | | | |
| CryLas | FQCW 266 | DP/CW/SS Laser | 266 nm | 0.6 mm | 70 W |
| Omicron | LED MOD | LEDMOD lab | 17 bands | Optical | 300 mw to |
| Laser | series | series | between 255 nm | Fiber | 27 W |
| | | | to 950 nm | coupled, | |
| | | | | 1 mm or | |
| | | | | 2 mm | |
| | | | | diameter | |

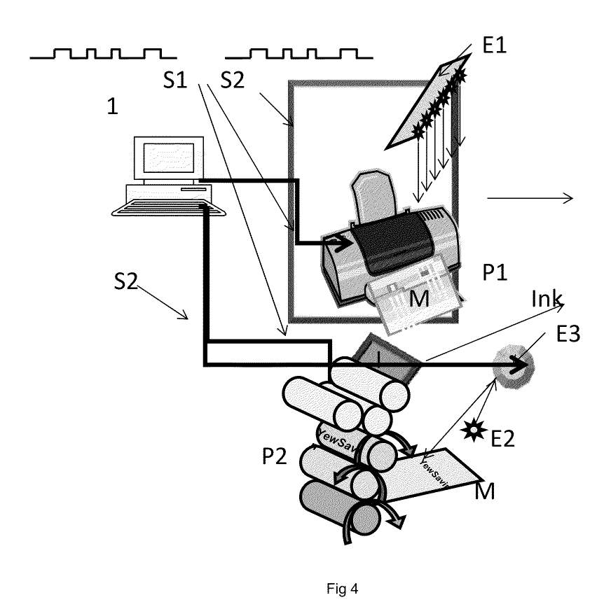

In another example embodiment, a system for parallel processing and exposure of films as is used. FIG. 4 provides a system diagram for an example embodiment of a system configuration for the digitally controlled EOD system and processes. In one example design embodiment, computer 1 is connected to a print mechanism such as an inkjet printer P1 or an offset mechanism P2, and a light source E1, through electrical signal and power control cables S1 and S2. The inks I of the inkjet or offset system may have high absorbance in the radiation band produced by sources E1 and E2. The energy from source E2 may be delivered with rotating mirror E3. The process of EOD comprises the sending of signals for printing through S1; and sending a synchronous, asynchronous or a delay added signal to light sources E1 and E2. Signal S1 causes the deposition of high absorbance inks I or film precursors I on the media M in the desired pattern, and signal S2 causes exposure of the locations of the deposited ink and film precursors. In cases where the position of deposition and exposure points are distant, an optional time delay corresponding to the time interval of travel between the deposition points to exposure point may be present in (raster) signal S1 and signal S2.

In another example embodiment, a high absorbance magenta ink may be produced by addition of 0.5% indo-cyanine green to commercially available Epson magenta ink compatible with Artisan 50 Ink Jet printer. The ink shows unaltered magenta color in human visual observation, and shows intense absorption peaks at the 780 nm band, which is invisible to humans.

In another example embodiment, an EOD system using commercially available Artisan 50 as an inkjet platform was built. A non-limiting example of a commercially available Epson Artisan printer was modified by mounting a LASER such as a non-limiting example of a Northrup-Grumman (Minnesota) 40 W 780 nm laser fitted with a cooling assembly and control integrated circuits, receiving signals from a computer and delivering the signals to the LASER and print cartridges. Inks as prepared in previous examples may be loaded in the ink cartridges, and the print mechanism may be activated with or without radiation source, in this case a LASER. Prints of bars were deposited on HP glossy photo paper. The extent of the drying of inks may be determined by positioning HP inkjet color lock paper over the films and running a pressure roller at 1 and 2 seconds after the film has exited the printer. Table 2 shows results of the experiment with commercial inks, with both laser on and laser off.

TABLE 2
Experimental results for EOD system test using EOD and
commercial inks

| Experiment | Ink | LASER | % Ink Transfer |
|---|---|---|---|
| 1 | Commercial Cyan | OFF | >20% |
| 2 | Commercial Magenta | OFF | >20% |
| 3 | Commercial Cyan | ON | >20% |
| 4 | Commercial Magenta | ON | >20% |
| 5 | EOD Cyan | OFF | >20% |
| 6 | EOD Cyan | ON | 0% |
| 7 | EOD Magenta | OFF | >20% |
| 8 | EOD Magenta | ON | 0% |

Inks with high absorbance dry significantly faster due to significantly higher energy absorption.

Although systems and methods of the present disclosure has been described in detail, it should be understood that various changes, substitutions and alterations can be made thereto without departing from the spirit and scope of the disclosure as defined by the appended claims.

Therefore, at least the following is claimed:

1. A composition comprising:
at least one film precursor; and
an absorber configured to absorb radiation at a wavelength of a particular radiated energy.

2. The composition of claim 1, wherein the absorber is matched to a processing radiation wavelength with a full width half maximum difference of no more than approximately 100 nm.

3. The composition of claim 1, wherein the composition is ink used in non-contact printing.

4. The composition of claim 1, wherein the composition is toner used in dry-toner electro-photography containing resins and colorants.

5. The composition of claim 1, wherein the composition is toner used in liquid electrophotography, containing at least one of a resin, a colorant, and hydrocarbon carriers.

6. The composition of claim 1, wherein the composition is used in contact printing methods.

7. A method comprising:
depositing a composition on a substrate, the composition comprising a film precursor and an absorber; and
irradiating the composition with a particular wavelength, the absorber having been selected to absorb radiation at the particular wavelength.

8. The method of claim 7, wherein the absorber is matched to a processing radiation wavelength with full wavelength half maximum difference of no more than approximately 100 nm.

9. The method of claim 7, wherein the irradiation is imagewise and is digitally controlled and synchronized to expose the deposited areas.

10. The method of claim 9, wherein the deposited areas are exposed by at least one of X-Y galvo, flying spot-rotating mirror raster, print bar modular segment array, fiber optic array, print head attached die, fiber array attached to print head, print bar LED, and LASER element array.

11. The method of claim 7, wherein the composition further comprises polymers and/or polymer precursors.

12. The method of claim 7, wherein the irradiation forms a solid film resulting in connecting and trapping particles.

13. The method of claim 7, wherein the absorption of the radiation causes loss of solvent resulting in a semi solid or solid film.

14. The method of claim 7, wherein the absorption of the radiation causes fusion and reconstitution of particles or film segments.

15. The method of claim 7, wherein the irradiation causes polymerization of components of the film precursor.

16. A printer comprising:
a deposition mechanism configured for depositing a composition on a substrate; and
an irradiation source configured to irradiating the composition with a particular wavelength, the composition comprising a film precursor and an absorber, the absorber selected to absorb radiation at the particular wavelength.

17. The printer of claim 16, wherein the absorber is matched to a processing radiation wavelength with a full width half maximum difference of no more than approximately 100 nm.

18. The printer of claim 16, wherein the composition is ink used in non-contact printing.

19. The printer of claim 16, wherein the composition is toner used in dry-toner electro-photography containing resins and colorants.

20. The printer of claim 16, wherein the composition is toner used in liquid electrophotography, containing at least one of a resin, a colorant, and hydrocarbon carriers.
